(19) United States
(12) Patent Application Publication
(10) Pub. No.: US 2006/0062221 A1
(43) Pub. Date: Mar. 23, 2006

(54) Routing table automatic setting method

(75) Inventor: Hirohisa Mori, Nishikyo-ku (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Center for Advanced Science and Technology Incubation, Ltd., Chiyoda-ku (JP)

(21) Appl. No.: 11/233,930

(22) Filed: Sep. 23, 2005

Related U.S. Application Data
(63) Continuation-in-part of application No. PCT/JP04/04025, filed on Mar. 24, 2004.

(30) Foreign Application Priority Data
Mar. 25, 2003 (JP) 2003-083911

(51) Int. Cl. H04L 12/56

(52) U.S. Cl. 370/392

(57) ABSTRACT

In the present invention, a method for automatically setting a routing table is provided with the following steps. (1) authenticating consistency of priority for each entry contained in the routing table in the event that there is a change in the table within the node; (2) updating entry(ies) where priority(ies) is(are) to be made high to maintain consistency with high priority(ies); (3) holding old information for a fixed period of time for entry(ies) where the priority becomes low in order to maintain consistency; and (4) acquiring consistency for the priority(ies) after a fixed time has elapsed. The automatic setting method can also be further provided with the following step: (5) before a fixed period of time elapses, sending a routing table that has acquired priority consistency to other nodes in the event that the routing information for the node has been referenced from other nodes. This step can also be executed using a separate step from the processing of the step (3).

### CROSS REFERENCE TO RELATED APPLICATIONS

This application is a continuation in part application based on PCT/JP2004/004025 filed Mar. 24, 2004, claiming a priority right from Japanese patent application No. 2003-083911 filed Mar. 25, 2003.

### BACKGROUND OF THE INVENTION

1. Field of the Invention

The present invention relates to a method for automatically setting a routing table.

2. Description of Related Art

The inventor has already proposed an algorithm for automatically allotting routable addresses in accordance with a plurality of physical networks (Japanese Patent Laid-open Publication No. 2001-53806). This algorithm is referred to as “ACRP” in the following. In the event that address binding is implemented in reality using subnet addresses for multiple stages using ACRP, a phenomenon occurs where an address cannot be decided in reality depending on the timing.

What kind of time an address cannot be decided for is described in the following. When a subnet address exists, in ACRP, one priority is given to one subnet itself for the nodes collectively. With ACRP, a method for assigning priority is such that priority of nodes belonging to the subnet that are the highest are taken to be subnet priorities. If the strongest node from the subnet is omitted for whatever reason, the priority of the subnet as a whole is changed. However, it takes time for this change to propagate over the whole of the subnet. During this transmission time, portions of different priorities within a single subnet can be put temporarily into a group.

If the priority is different even for the same group for an ACRP rule, then the presence of a different subnet is recognized. If a different subnet exists for the same address, then one or other of the subnets is deleted as a result of comparing priorities. Namely, the ability to classify different priorities within a subnet even temporarily means that nodes at boundary lines of two classifications may be erroneously recognized as having the same address but being connected to different subnets. Subnets of high priority are therefore deleted in order to avoid address overlapping.

Here, it is taken that a loop exists at part of the network as shown in FIG. 1.

Four nodes from node A to node D are taken to be the same subnet. The node A is taken to be the node with the highest priority. Under these conditions, it is then assumed that the node A goes off the network for some reason.

First, one of the nodes (for example, node C) recognizes that node A has gone using information collected periodically from the surroundings. As a result, the subnet priority occurring at node C is revised to being low. Next, node B similarly carries out information collection from the environment, and updates the subnet for node B to having a low priority. At this time, node D is taken to remain having a high priority.

When the priority information in the possession of node D is similarly updated, the subnet is stabilized simply by changing the overall priority. However, depending on the timing, the node C again collects information for the surroundings before the information for node D is updated. In doing so, its own subnet and the subnet of the node D have the same address with different priorities. The node C therefore has to be given an address once more in accordance with the ACRP algorithm. The new address is therefore made to be a subnet address for node D as a result of the information from the surroundings. In doing so, the priority of the subnet for the node C is again changed to being high.

A low priority is transmitted from node B to node D in the same manner as a low priority was transmitted from node C to node B, and depending on the timing, the node B becomes a high priority so as to be the same as the process of low priority that follows from node C to B and B to D. In doing so, the priority circulates around this loop and an address is therefore never decided.

### SUMMARY OF THE INVENTION

As the present invention sets out to resolve this situation, it is advantageous for the present invention to provide a method for controlling priority of routing tables.

A method for automatically setting a routing table of the present invention is therefore provided with the following steps.

(1) authenticating consistency of priority for each entry contained in the routing table in the event that there is a change in the table within the node;

(2) updating entry(ies) where priority(ies) is(are) to be made high to maintain consistency with high priority(ies);

(3) holding old information for a fixed period of time for entry(ies) where the priority becomes low in order to maintain consistency; and

(4) acquiring consistency for the priority(ies) after a fixed time has elapsed.

The automatic setting method can also be further provided with the following step:

(5) before a fixed period of time elapses, sending a routing table that has acquired priority consistency to other nodes in the event that the routing information for the node has been referenced from other nodes. This step can also be executed using a separate step from the processing of the step (3).

A method for automatically setting a routing table of the present invention may be provided with the following steps.

(1) maintaining node stability;

(2) determining bias in variation of addresses occurring at surrounding nodes after the node has become stable;

(3) invalidating addresses already allotted to the nodes and re-allotting addresses in the event that variation of addresses is determined to be biased in step (2);

The computer program of the present invention executes these setting methods on a computer.

A system using a computer for automatically setting a routing table in this invention executes the steps (or functions) of:

(1) authenticating consistency of priority for each entry contained in the routing table in the event that there is a change in the table within the node;

(2) updating entry(ies) where priority(ies) is(are) to be made high to maintain consistency with high priority(ies);

(3) holding old information for a fixed period of time for entry(ies) where the priority becomes low in order to maintain consistency; and

(4) acquiring consistency of the priority(ies) after a fixed time has elapsed.

In another aspects, a system using a computer for automatically setting a routing table in this invention executes the steps (or functions) of:

(1) maintaining node stability;

(2) determining bias in variation of addresses occurring at surrounding nodes;

(3) invalidating addresses already allotted to the nodes and re-allotting addresses in the event that variation of addresses is determined to be biased in step (2).

### BRIEF DESCRIPTION OF THE DRAWINGS

FIG. 1 is a view illustrating a method for automatically setting a routing table of a first embodiment of the present invention, and is a view illustrating network configuration.

FIG. 2 is a block view illustrating a node configuration.

FIG. 3 is a flowchart illustrating a method for automatically setting a routing table of a first embodiment of the present invention.

FIG. 4 is a view illustrating a method for automatically setting a routing table of a first embodiment of the present invention, and FIG. 4(a) to FIG. 4(c) are views of entries.

FIG. 5 is a flowchart illustrating a method for automatically setting a routing table of a second embodiment of the present invention.

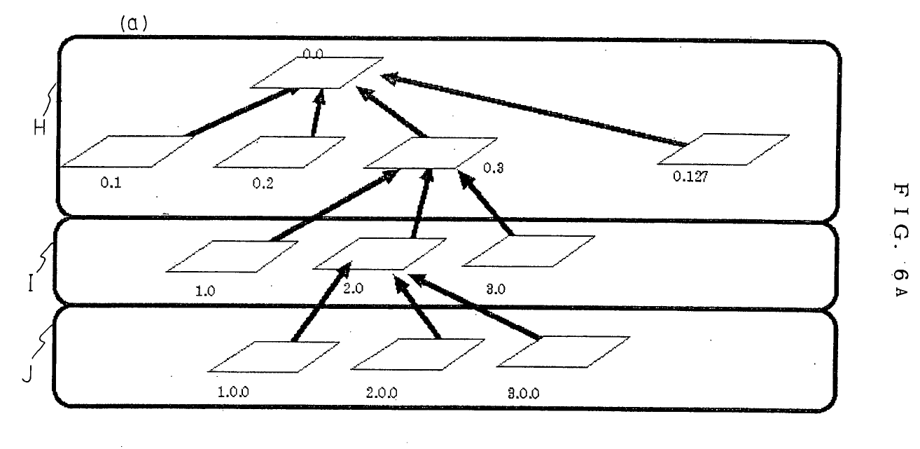

FIG. 6 is a view illustrating a method for automatically setting a routing table of the second embodiment of the present invention, and is a view illustrating network configuration, where FIG. 4(a) and FIG. 4(b) are views of nodes.

FIG. 7 is a view illustrating a method for automatically setting a routing table of the embodiments of the present invention, and is a view of a node.

### DESCRIPTION OF THE PREFERRED EMBODIMENTS

### First Embodiment

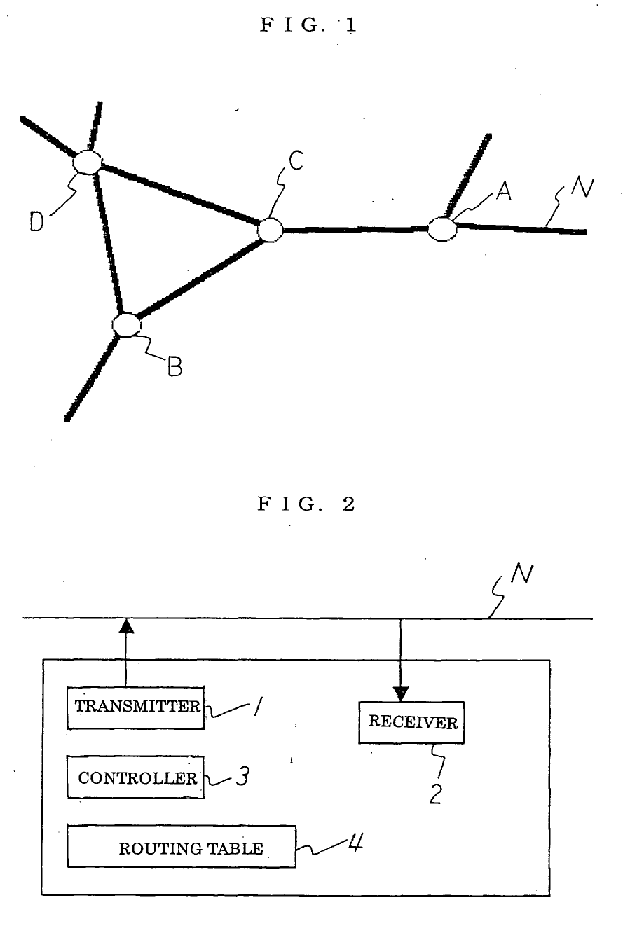

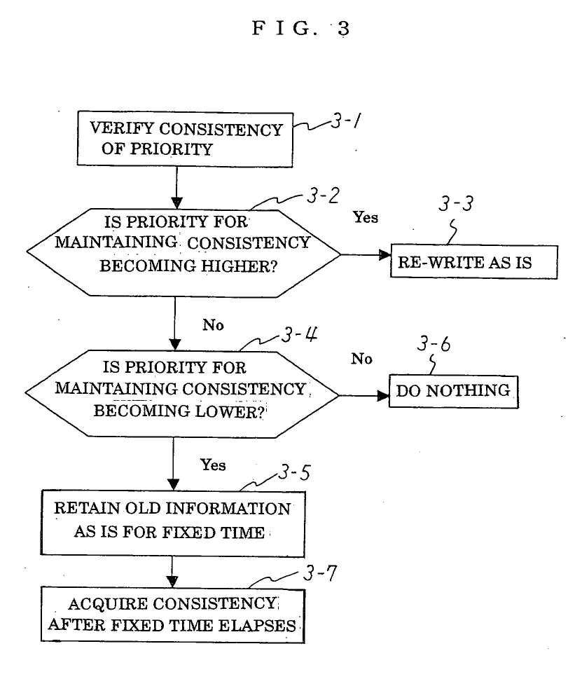

A description is now given below of an automatic setting method of a first embodiment of the present invention. First, a description is given of the configuration of a node used in this method. As shown in FIG. 2, this node is equipped with a transmitter 1, receiver 2, controller 3 and routing table 4 as functional elements. The transmitter 1 and receiver 2 are connected to the network N. The controller 3 sends routing information to another node in accordance with information of the routing table 4 and updates the routing table 4 in accordance with information from other nodes. The operation is described in detail in the following. The routing table 4 is a table for storing routing information. The node configuration is the same as a normal node configuration. Further the topology of the node in this embodiment is the same as for FIG. 1.

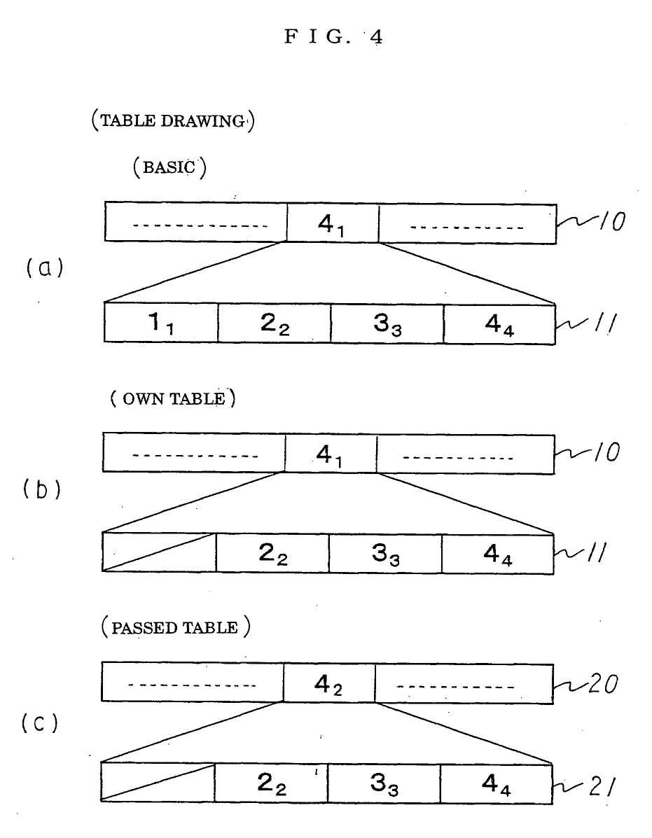

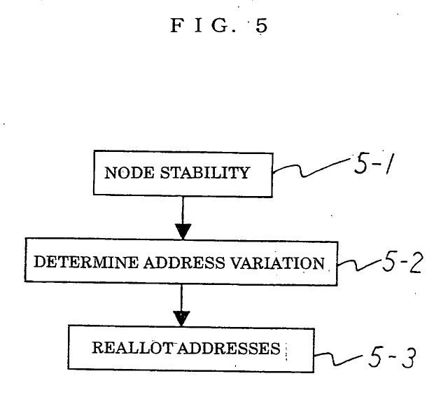

Next, the automatic setting method of the first embodiment is described with reference to FIG. 1, FIG. 3 and FIG. 4. First, initial conditions are assumed to be as follows. The table occurring at node C is taken to be in the state of FIG. 4(a) in an initial state. In this example, 4 is an entry in the entry list 10, and entries 1, 2, 3 and 4 are present in the entry list 11 of the lower order subnet. The addresses shown here are 4.1, 4, 2, 4.3 and 4.4. These addresses are shown as 4.X. The priority of entry 4 of the list 10 is taken to be the maximum priority “1” of the node belonging to subnet 4.X occurring at a lower order.

Based on this way of thinking of priority, in the event that the priority of the entry corresponding to the address of this node for all levels coincides with the highest priority in the priority of a subnet one below, it is taken that consistency is defined, and in the case that there is no coincidence, it is taken that consistency is not defined.

In the event that the content of the routing table is rewritten (i.e. changed) for whatever reason, consistency is verified using this verification method (step 3-1).

In the event that a node recognizes that consistency cannot be obtained with its own routing table, a determination of “whether or not to make an entry priority high in order to maintain consistency” is made (step 3-2). If this is the case, the priority for the entry is immediately re-written, and consistency is maintained. If the determination in step S3-2 is No, a determination is made as to whether or not it is necessary to lower the priority in order to maintain consistency (step 3-4). If this is the case, consistency cannot be obtained for each entry immediately, and old information is held as is (step 3-5). The length of time of retention is set to an appropriate numerical value of, for example, the order of five minutes, and if the determination in step S3-4 is No, then nothing takes place because there is no change in the priority (step 3-6). After step 3-5, when a fixed time has elapsed, the priority of each entry is re-written so as to maintain consistency.

In the event that the routing table of the node is referred to by another node for whatever reason while the priority is held, the node temporarily copies the routing table. Consistency is therefore acquired for all of the entries for the copied routing table. Next, this routing table is sent to the node outputting the reference request.

In this embodiment, in the event that the node with the highest priority within the subnet becomes detached from the network for whatever reason, the priority of the subnet containing this node is lowered. However, in this embodiment, while the old priority is saved, the routing table information propagates over the whole of the subnet, but the problematic priority remains held high, and a situation where a number of items of information of different priorities exist within a subnet does not occur. The retention time is therefore cut because the information of the routing table propagates over the whole of the subnet, and consistency can be obtained for the routing tables for each node. After the referred routing table is copied, consistency is obtained and passed over to the reference side. Direct notification of the change in priority then takes place to outside of the subnet and in this embodiment also, time efficiency in allotting addresses is maintained outside of the subnet.

### Second Embodiment

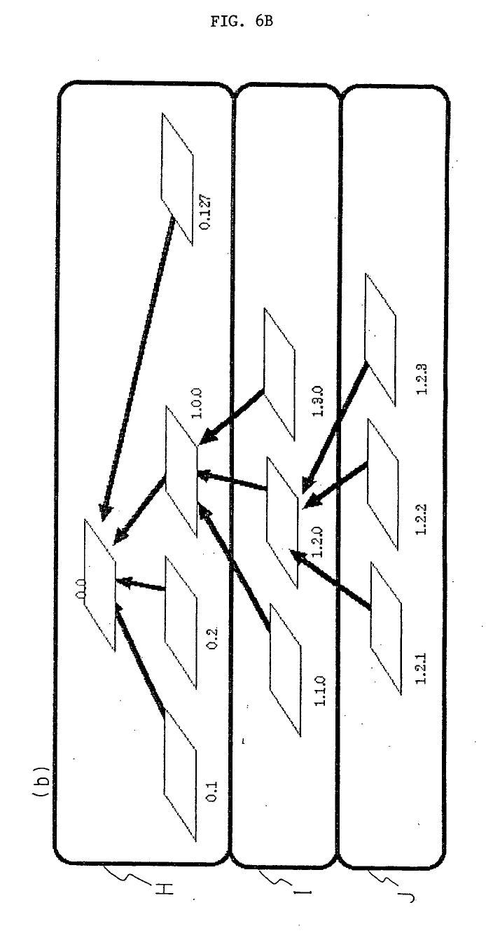

Next, a description is now given of an automatic setting method of a second embodiment of the present invention. The node configuration used in this method is the same as for the first embodiment. Further, as shown in FIG. 6(a), this embodiment operates effectively when the nodes are connected in a tree structure. A description is given dividing the nodes into groups of H, I and J.

First, it is assumed that nodes of addresses 0.1 to 0.127 exist below the address 0.0 in an initial state. Next, it is taken that three nodes are made below node 0.3. Addresses for these three nodes are then 1.0, 2.0, and 3.0. A method of adding upper order addresses with addresses arranged in a lower order is referred to as a bignum integer address method. This method itself is well-known. Further, when nodes below node 2.0 are increased, addresses such as 1.0.0, 2.0.0, 3.0.0 are thrown away for these nodes. This means that the lower order values for the addresses are wasted and the number of places for the addresses is increased. At this time; as shown in FIG. 6(b), is has also been considered to allot addresses to additional nodes while changing lower order addressed but in the case of the bignum method, it is difficult to resolve an address from a lower order and allotting in this manner is difficult.

Nodes in this embodiment confirm whether states exist where consistency of the routing tables cannot be attained or where states exist where addresses cannot be allotted (step 5-1). A state where an address is allotted, consistency of the routing table is maintained, and a fixed period of time has already elapsed is referred to as a “node stable state”. If a node stable state is attained, inconsistencies in the addresses are determined using the following conditions (step 5-2).

(Condition)

The number of nodes where the node and the subnet address of the second digit from the lowest ranked address is the same, and where nodes are separated by two hops or more:

A. The number of nodes where the nodes exist one hop away, or are adjacent, and where the node and the subnet address of the second digit from the lowest rank address are different and the number of nodes belonging to the subnet is remarkably small (for example, only one): B.

where the address number: M (where M=256 in the case of an IP address)

At this time,

If A≈M where A+B>>M is fulfilled, it is determined that the variation in the addresses is unevenly distributed.

In the above conditions, the extent of “approaching (≈) M”, “sufficiently larger than (>>) M” is decided by the system performance. For example, this is determined to be close to M when A is 90% or more of M. Further, in the case that, for example, A+B is 150% of M, this is determined to be sufficiently larger than M. The extent to which this is preferable in reality is decided based on the balance of the system.

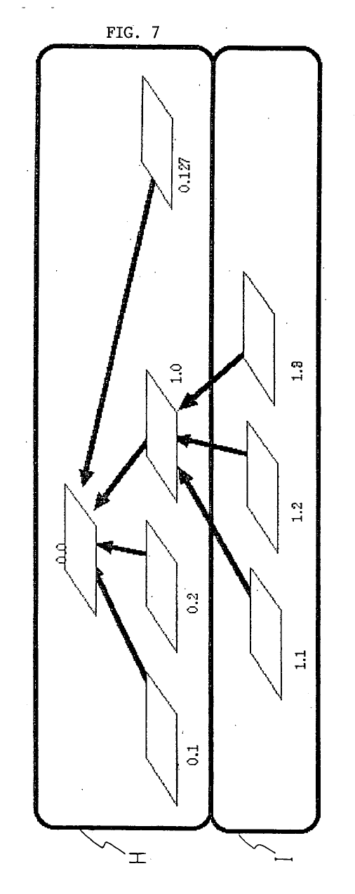

Nodes satisfying the aforementioned conditions are re-allotted addresses in the following manner (step 5-3), and this node is taken to be referred to as a noted node. First, at a node in a subnet I positioned lower than the noted node 0.3, a node occurring in a lower order subnet J for which the node number is a minimum is searched for. For example, in the example of FIG. 6(a), this corresponds to node 1.0. Addresses having the same subnet address as the retrieved node are allotted to noted nodes. As a result, the address of a noted node can be taken to be 1,0. This situation is shown in FIG. 7.

When an address of a noted node changes, the addresses of the surrounding nodes also have to change, otherwise routing between these nodes is not carried out. If the ACRP is implemented, then addresses are automatically re-allotted to the surrounding nodes. At this time, in the event that a new address is allotted to a node, in ACRP theory, in order to allot (bind) addresses so as to belong to a subnet where the number of nodes is small, eventually the number of nodes having the same subnet as the noted node will increase. Namely, as shown in FIG. 7, it is possible to allot addresses 1.1, 1.2, 1.3 to a node of a lower order. As a result, wastefulness of the lower order address values is prevented, and it is possible to suppress increases in the number of address digits. The above described embodiments and practical examples are merely given as examples and in no way show indispensable configurations of the present invention. Various structures are possible without departing from the gist of the present invention. Further, it is also possible for the structural elements in each of the aforementioned embodiments to act as functional elements. One functional element may also be unified with other elements and a single element may also be implemented using a plurality of parts and software. The method of implementing the functional elements may employ hardware or may employ computer software. Further, the connection states for between functional elements may also be via a network. Namely, a plurality of functional elements may also be positioned separated from each other.

According to the present invention, the present invention is advantageous in providing a method for controlling priority of routing tables. Further, according to the present invention, an increase in the number of address digits can be suppressed.

What is claimed is:

1. A method for automatically setting a routing table comprising the steps of:
(1) authenticating consistency of priority for each entry contained in the routing table in the event that there is a change in the table within the node;
(2) updating entry(ies) where priority(ies) is(are) to be made high to maintain consistency with high priority(ies);
(3) holding old information for a fixed period of time for entry(ies) where the priority becomes low in order to maintain consistency; and
(4) acquiring consistency of the priority(ies) after a fixed time has elapsed.

2. The method for automatically setting a routing table of claim 1, further comprising the step of:
(5) sending a routing table that has acquired priority consistency to other nodes in the event that the routing information for the node has been referred to by other nodes.

3. A method for automatically setting a routing table comprising the steps of:
(1) maintaining node stability;
(2) determining bias in variation of addresses occurring at surrounding nodes;
(3) invalidating addresses already allotted to the nodes and re-allotting addresses in the event that variation of addresses is determined to be biased in step (2).

4. A computer program executing the setting method of claim 1 using a computer.

5. A computer program executing the setting method of claim 2 using a computer.

6. A computer program executing the setting method of claim 3 using a computer.

7. A system using a computer for automatically setting a routing table executing the steps of:
(1) authenticating consistency of priority for each entry contained in the routing table in the event that there is a change in the table within the node;
(2) updating entry(ies) where priority(ies) is(are) to be made high to maintain consistency with high priority(ies);
(3) holding old information for a fixed period of time for entry(ies) where the priority becomes low in order to maintain consistency; and
(4) acquiring consistency of the priority(ies) after a fixed time has elapsed.

8. A system using a computer for automatically setting a routing table executing the steps of:
(1) maintaining node stability;
(2) determining bias in variation of addresses occurring at surrounding nodes;
(3) invalidating addresses already allotted to the nodes and re-allotting addresses in the event that variation of addresses is determined to be biased in step (2).
